(19) United States
(12) Patent Application Publication
(10) Pub. No.: US 2019/0252781 A1
(43) Pub. Date: Aug. 15, 2019

(54) COIL DEVICE

(71) Applicant: Murata Manufacturing Co., Ltd., Nagaokakyo-shi (JP)

(72) Inventors: Atsushi ISAYAMA, Nagaokakyo-shi (JP); Jyunichi NANJYO, Nagaokakyo-shi (JP); Nobuyuki TENNO, Nagaokakyo-shi (JP)

(21) Appl. No.: 16/395,294

(22) Filed: Apr. 26, 2019

Related U.S. Application Data
(63) Continuation of application No. PCT/JP2018/006674, filed on Feb. 23, 2018.

(30) Foreign Application Priority Data
Mar. 27, 2017 (JP) 2017-060772
Oct. 12, 2017 (JP) 2017-198129

(51) Int. Cl. H01Q 7/00; H04B 5/02; H04B 5/00; H01Q 1/38; H01G 4/228; H01F 5/00

(52) U.S. Cl. CPC H01Q 7/00; H04B 5/02; H01F 5/003; H01Q 1/38; H01G 4/228; H04B 5/0081

(57) ABSTRACT

A coil device includes a device body and terminal electrodes. Coils are provided in the device body. The device body has a laminated structure including insulating layers, and includes a mounting surface orthogonal to the laminating direction of the insulating layers. The terminal electrodes are located on the mounting surface. An entirety of the terminal electrodes overlaps a coil opening of the coils when viewed in the laminating direction.

### CROSS REFERENCE TO RELATED APPLICATIONS

This application claims the benefit of priority to Japanese Patent Application No. 2017-060772 filed on Mar. 27, 2017 and Japanese Patent Application No. 2017-198129 filed on Oct. 12, 2017, and is a Continuation Application of PCT Application No. PCT/JP2018/006674 filed on Feb. 23, 2018. The entire contents of each of these applications are hereby incorporated herein by reference.

### BACKGROUND OF THE INVENTION

### 1. Field of the Invention

The present invention relates to a coil device, and more particularly, to a coil device including a device body, in which a coil is provided, and terminal electrodes.

### 2. Description of the Related Art

Japanese Patent No. 5741782 discloses a coil device (an antenna device) including a device body and terminal electrodes. The device body has a laminated structure including multiple insulating layers on which conductor patterns are formed. The terminal electrodes are formed on the surface of the device body. The multiple conductor patterns form a coil. The terminal electrodes are disposed at multiple positions at which multiple conductor patterns overlap the coil when viewed in the winding axis direction of the coil.

Typically, when multiple insulating layers, on which conductor patterns are formed, are laminated on top of one another, the thickness of the conductor patterns is added to a portion in which the conductor patterns are formed. Therefore, the thickness, in the laminating direction, of the multiple insulating layers is larger than the thickness of the other portions, and the flatness of the device body is not able to be achieved.

That is, in the coil device described in Japanese Patent No. 5741782, the terminal electrodes are formed in a portion, having reduced flatness, of the mounting surface of the device body. Therefore, the mountability is decreased when the coil device is mounted on an external circuit substrate or the like. In addition, when the coil device is mounted on an external circuit substrate or the like, mounting failure (connection failure) may occur.

### SUMMARY OF THE INVENTION

Preferred embodiments of the present invention provide coil devices which each have outstanding mountability when the coil device is mounted on an external circuit substrate or other suitable substrate, and which each reduce or prevent mounting failure of the coil device on an external circuit substrate or other suitable substrate.

A coil device according to a preferred embodiment of the present invention includes a device body and terminal electrodes. The device body has a laminated structure including a plurality of insulating layers, includes a mounting surface orthogonal or substantially orthogonal to a laminating direction of the plurality of insulating layers, and includes a coil provided therein. The coil includes one turn or more. The terminal electrodes are provided on the mounting surface, and are connected to pads provided on the circuit substrate. An entirety of the terminal electrodes overlaps a coil opening of the coil when viewed in the laminating direction. An entirety of the device body overlaps the circuit substrate when viewed in the laminating direction.

In this configuration, the terminal electrodes are provided in a portion, having improved flatness, of the mounting surface. Therefore, compared with the case in which the terminal electrodes are provided at positions at which the terminal electrodes overlap the coil when viewed in the laminating direction, a coil device having a mounting surface with improved flatness is achieved. Accordingly, a coil device which has outstanding mountability when the coil device is mounted on an external circuit substrate or other suitable substrate, and which reduces or prevents mounting failure of the coil device on an external circuit substrate or other suitable substrate is achieved.

In a coil device according to a preferred embodiment of the present invention, a thickness of the device body, in the laminating direction, of a portion overlying the coil when viewed in the laminating direction may be larger than a thickness, in the laminating direction, of a portion overlying the coil opening when viewed in the laminating direction.

In a coil device according to a preferred embodiment of the present invention, a minimum distance from an outer edge portion of the coil to an end portion of the device body is preferably shorter than a conductor width (line width) of the coil. In this configuration, a coil whose diameter is large relative to the size of the device body is provided. Therefore, the range and distance in which magnetic flux radiates (concentrates) is relatively larger. As a result, a coil device having good communication characteristics is able to be achieved.

In a coil device according to a preferred embodiment of the present invention, the device body preferably includes a magnetic material. This configuration provides a coil device having a given inductance value, without increasing the size of the device body.

In a coil device according to a preferred embodiment of the present invention, the magnetic material may include a first magnetic layer positioned on the mounting surface side relative to the coil. When the coil device includes only the first magnetic layer, the magnetic shield effect of the first magnetic layer reduces or prevents the state in which a magnetic field from the coil radiates to the mounting surface side. Therefore, when the coil device is mounted on a circuit substrate or other suitable substrate, unnecessary coupling between the coil and a conductor positioned on the mounting surface side is able to be reduced or prevented.

In a coil device according to a preferred embodiment of the present invention, the device body may include a top surface facing the mounting surface. The magnetic material may include a second magnetic layer positioned on the top surface side relative to the coil. When the device body includes the first magnetic layer and the second magnetic layer, the coil has a vertically symmetrical structure in which the coil is sandwiched between the first magnetic layer and the second magnetic layer. Therefore, deformation, such as warping, of the device body, which is produced during firing, is able to be reduced or prevented.

A coil device according to a preferred embodiment of the present invention includes a device body and terminal electrodes. The device body has a laminated structure including a plurality of insulating layers, includes a mounting surface orthogonal or substantially orthogonal to a laminating direction of the plurality of insulating layers, and includes a coil provided therein. The coil includes a plurality of turns. The terminal electrodes are provided on the mounting surface, and are connected to pads provided on the circuit substrate. The coil includes a first coil conductor portion and a second coil conductor portion connected in series to the first coil conductor portion. The first coil conductor portion is positioned on the mounting surface side relative to the second coil conductor portion in the laminating direction. An entirety of the terminal electrodes overlaps a coil opening of the first coil conductor portion when viewed in the laminating direction. An entirety of the device body overlaps the circuit substrate when viewed in the laminating direction.

In this configuration, the terminal electrodes are provided in a portion, having improved flatness, of the mounting surface. Therefore, compared with the case in which the terminal electrodes are provided at positions at which the terminal electrodes overlap the first coil conductor portion when viewed in the laminating direction, a coil device having a mounting surface with improved flatness is achieved. Therefore, a coil device which has outstanding mountability when the coil device is mounted on an external circuit substrate or other suitable substrate and which reduces or prevents mounting failure of the coil device on an external circuit substrate or other suitable substrate is achieved.

In a coil device according to a preferred embodiment of the present invention, a thickness of the device body, in the laminating direction, of a portion overlying the first coil conductor portion when viewed in the laminating direction is larger than a thickness, in the laminating direction, of a portion overlying the coil opening of the first coil conductor portion when viewed in the laminating direction.

In a coil device according to a preferred embodiment of the present invention, a minimum distance from an outer edge portion of the first coil conductor portion to an end portion of the device body is preferably shorter than a conductor width of the first coil conductor portion. In this configuration, a coil whose diameter is large relative to the size of the device body is provided. Therefore, the range and distance in which magnetic flux radiates (concentrates) are relatively larger. As a result, a coil device having good communication characteristics is able to be achieved.

In a coil device according to a preferred embodiment of the present invention, the device body preferably includes a magnetic material. This configuration provides a coil device, having a given inductance value, without increasing the size of the device body.

In a coil device according to a preferred embodiment of the present invention, the magnetic material may include a first magnetic layer positioned on the mounting surface side relative to the first coil conductor portion. When the coil device includes only the first magnetic layer, the magnetic shield effect of the first magnetic layer reduces or prevents the state in which a magnetic field from the coil radiates to the mounting surface side. Therefore, when the coil device is mounted on a circuit substrate or other suitable substrate, unnecessary coupling between the coil and a conductor positioned on the mounting surface side is able to be reduced or prevented.

In a coil device according to a preferred embodiment of the present invention, the device body may include a top surface facing the mounting surface. The magnetic material may include a second magnetic layer positioned on the top surface side relative to the coil. When the device body includes the first magnetic layer and the second magnetic layer, the coil has a vertically symmetrical structure in which the coil is sandwiched between the first magnetic layer and the second magnetic layer. Therefore, deformation, such as warping, of the device body, which is produced during firing, is able to be reduced or prevented.

Preferred embodiments of the present invention each achieve a coil device which has high mountability when the coil device is mounted on an external circuit substrate or other suitable substrate and which reduces or prevents mounting failure of the coil device on an external circuit substrate or other suitable substrate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is an external perspective view of a coil device 301 according to a first preferred embodiment of the present invention. FIG. 1B is a perspective view of the schematic shape of coils provided inside the coil device 301.

FIG. 2A is a plan view of the coil device 301. FIG. 2B is an A-A sectional view of FIG. 2A.

FIG. 3 is a plan view of multiple insulating layers S1 to S14 included in the coil device 301.

FIG. 4A is a perspective view of an antenna device 401 according to the first preferred embodiment of the present invention. FIG. 4B is a perspective view of the state in which the coil device 301 is removed from the antenna device 401.

FIG. 5 is a sectional view of a coil device 302 according to a second preferred embodiment of the present invention.

FIG. 6A is a sectional view of a coil device 303A according to a third preferred embodiment of the present invention. FIG. 6B is a sectional view of a coil device 303B according to the third preferred embodiment of the present invention.

### DETAILED DESCRIPTION OF THE PREFERRED EMBODIMENTS

Preferred embodiments of the present invention will be described below with reference to specific examples and the drawings. In the drawings, the same reference characters are used to denote the same or similar components. In consideration of easy description or understanding of main points, the preferred embodiments are described separately for the sake of convenience. However, a subset of the components in different preferred embodiments may be replaced or combined with one another. Common points to a first preferred embodiment will not be described in a second and subsequent preferred embodiments, and only different points will be described. In particular, similar advantageous effects due to similar configurations will be described in one preferred embodiment, not in every preferred embodiment.

A “coil device” described in each preferred embodiment is preferably, for example, a chip coil antenna. The “coil device” according to preferred embodiments of the present invention may be a chip inductor.

An “antenna device” described in each preferred embodiment may be used for both the transmission (power transmission) side and the reception (power reception) side of a signal (or power). Even when the “antenna device” is described as an antenna radiating magnetic flux, the antenna device is not limited to a source of emission of magnetic flux. Even when a magnetic flux generated by a transmission target antenna is received (interlinked), that is, even when the reception/transmission relationship is reversed, the same or similar advantageous effects are produced.

The “antenna device” described above is preferably an antenna device used for near-field communication, using magnetic field coupling, with a communication target antenna, or an antenna device used for near-field power transmission, using magnetic field coupling, with a power transmission target antenna, for example. In the case of communication, for example, the “antenna device” is preferably used in a communication system, such as NFC (Near field communication). In the case of power transmission, for example, the “antenna device” is preferably used in a power transmission system using magnetic field coupling in an electromagnetic induction system, a magnetic resonance system, or other suitable system. That is, the “antenna device” described above is used in a wireless transmission system in communication, power transmission, or other suitable system using at least magnetic field coupling. The “antenna device” described above encompasses a system in which wireless transmission with a transmission target antenna is substantially performed using electromagnetic field coupling (magnetic field coupling and electric field coupling).

The “antenna device” described above is preferably used, for example, in the HF band, especially in about 13.56 MHz or about 6.78 MHz, or in a frequency band near 13.56 MHz or near 6.78 MHz. The size of the antenna device is sufficiently smaller than the wavelength λ of the working frequency. Therefore, the radiation efficiency of an electromagnetic wave in the working frequency band is naturally low. The size of the antenna device is preferably equal to or less than about λ/10, for example. More specifically, the length of the current path of the antenna device is preferably equal to or less than about λ/10, for example. The wavelength herein indicates an effective wavelength obtained in consideration of the wavelength reduction effect due to the permittivity or the permeability of the base material of which a conductor is made.

“Electronic equipment” described in each preferred embodiment indicates various types of electronic equipment, for example, cellular phone terminals, such as a smartphone and a feature phone, wearable terminals, such as a smartwatch and smart glasses, portable PCs, such as a notebook PC and a tablet PC, information equipment, such as camera, a game machine, and a toy, and information media, such as an IC tag, an SD card, a SIM card, and an IC card, for example.

### First Preferred Embodiment

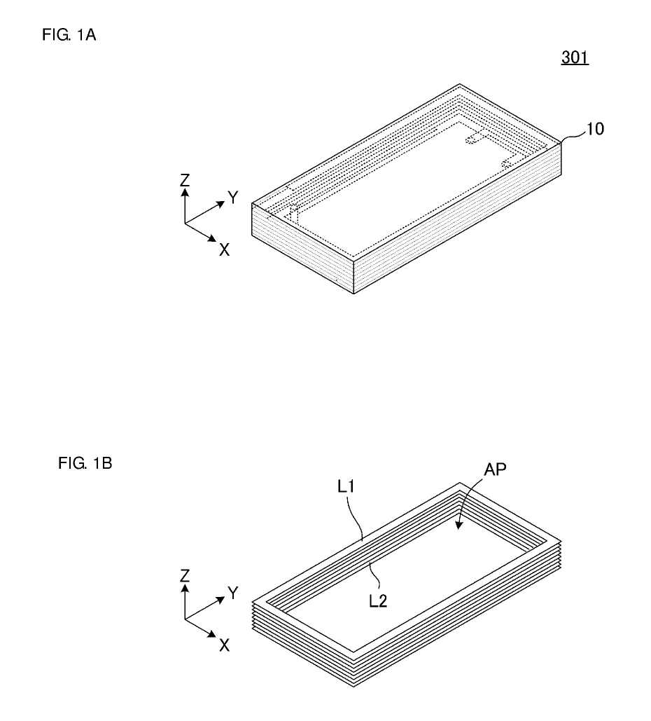

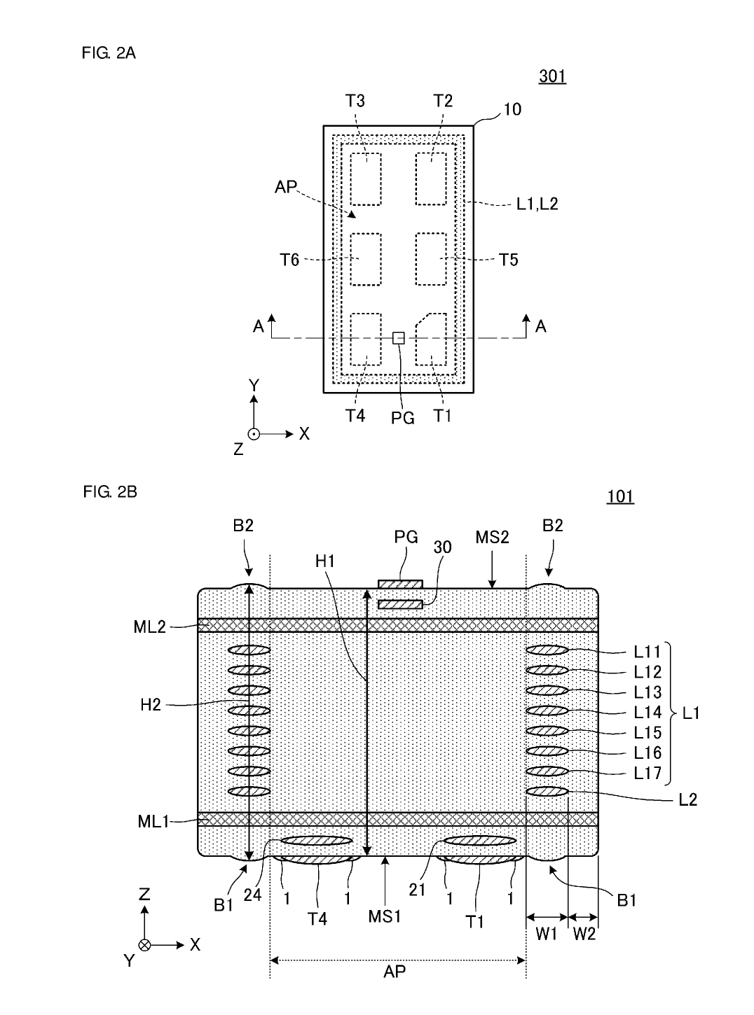

FIG. 1A is an external perspective view of a coil device 301 according to a first preferred embodiment of the present invention. FIG. 1B is a perspective view of the schematic shape of coils provided inside the coil device 301. FIG. 2A is a plan view of the coil device 301. FIG. 2B is an A-A sectional view of FIG. 2A. In FIG. 2A, to make the structure understandable, coils (a coil L1 and an auxiliary coil L2) are illustrated by using a dot pattern.

The coil device 301 includes a rectangular or substantially rectangular parallelepiped-shaped device body 10, and six terminal electrodes T1, T2, T3, T4, T5, and T6. In the device body 10, for example, a conductor (such as a coil) is provided in a low temperature co-fired ceramics (LTCC) dielectric ceramic.

The device body 10 has a laminated structure including multiple insulating layers (which are described in detail below), and includes a mounting surface MS1 and a top surface MS2 which face one another. The mounting surface MS1 and the top surface MS2 are surfaces orthogonal or substantially orthogonal to the laminating direction (Z-axis direction) of the multiple insulating layers.

As illustrated in FIGS. 1A and 2B, for example, the coil L1 and the auxiliary coil L2 are provided in the device body 10. The coil L1 is a helical coil which preferably includes, for example, about seven turns (one turn or more) and whose winding axis is parallel or substantially parallel to the Z-axis direction. As described in detail below, the coil L1 includes coil conductors L11, L12, L13, L14, L15, L16, and L17 and multiple layer connecting conductors. The auxiliary coil L2 is preferably a loop coil including less than about one turn, for example, and whose winding axis is parallel or substantially parallel to the Z-axis direction. The coil conductors L11 to L17 and the auxiliary coil L2 are conductor patterns whose main component is preferably, for example, Ag. As illustrated in FIG. 2B, for example, the coil conductors L11 to L17 and the auxiliary coil L2 substantially overlap one another when viewed in the Z-axis direction.

The device body 10 includes magnetic material. Specifically, as illustrated in FIG. 2B, the device body 10 includes a first magnetic layer ML1 and a second magnetic layer ML2. The first magnetic layer ML1 is positioned on the mounting surface MS1 side relative to the coils (the coil L1 and the auxiliary coil L2). The second magnetic layer ML2 is positioned on the top surface MS2 side relative to the coils. In other words, the coils are interposed between the first magnetic layer ML1 and the second magnetic layer ML2.

The six terminal electrodes T1 to T6 are preferably, for example, rectangular or substantially rectangular conductor patterns provided on the mounting surface MS1 of the device body 10. As described in detail below, the terminal electrode T1 is connected to one end of the coil L1. The terminal electrode T2 is connected to the other end of the coil L1. The terminal electrode T3 is connected to one end of the auxiliary coil L2. The terminal electrode T4 is connected to the other end of the auxiliary coil L2. The terminal electrodes T5 and T6 are mounting electrodes (dummy electrodes) which are not connected to the coils (the coil L1 and the auxiliary coil L2). The terminal electrodes T1 to T6 are conductor patterns whose main component is preferably, for example, Ag. The terminal electrodes T1 to T6 may be subjected to Au plating processing in which, for example, Ni is used in primary plating.

As illustrated in FIG. 2B, frame-shaped insulating films 1 are provided on the mounting surface MS1 of the device body 10. The insulating films 1 cover the outer edge portions (all around the edges) of the terminal electrodes T1 to T6. The insulating films 1 are protective films to prevent the terminal electrodes T1 to T6 from falling off, and are preferably obtained, for example, by firing a non-magnetic material (non-magnetic ferrite) paste.

As illustrated in FIG. 2B, a protrusion portion B1 is provided on the mounting surface MS1 of the device body 10. A protrusion portion B2 is provided on the top surface MS2 of the device body 10. The protrusion portions B1 and B2 are convex portions on the mounting surface MS1 and the top surface MS2 due to the coils (the coil L1 and the auxiliary coil L2) disposed inside the device body 10. The protrusion portions B1 and B2 are disposed along the shape of the coils when viewed in the Z-axis direction.

Typically, in the case of a laminated structure including multiple insulating layers on which conductor patterns are provided, the thickness of the conductor patterns is added to the portion in which the conductor patterns are provided. Therefore, the thickness, in the Z-axis direction, of the multiple insulating layers in the portion is larger than the thickness of the other portions. Thus, the protrusion portions described above are provided. Therefore, the protrusion portions B1 and B2 are disposed along the shape of the coils when viewed in the Z-axis direction. As the number of overlying conductor patterns (for example, the coil conductors L11 to L17 and the auxiliary coil L2) in the laminating direction (Z-axis direction) is increased, the amount of protrusion of the protrusion portions B1 and B2 from the surface of the device body tends to increase. As the conductor patterns provided inside the device body 10 are disposed closer to the mounting surface MS1 and the top surface MS2, the amount of protrusion of the protrusion portions B1 and B2 from the device body surface tends to increase.

As illustrated in FIG. 2B, in the device body 10, the thickness H2 is larger than the thickness H1 (H1<H2), where the thickness H1 indicates the thickness, in the Z-axis direction, of a portion overlying a coil opening AP when viewed in the Z-axis direction, and the thickness H2 is the thickness, in the Z-axis direction, of a portion (a portion in which the protrusion portions B1 and B2 are provided) overlying the coils (the coil L1 and the auxiliary coil L2) when viewed in the Z-axis direction.

The “coil opening” indicates an opening portion provided substantially by the coil conductors defining the coils when viewed in the Z-axis direction (the winding axis direction of the coils). Specifically, in the case of multiple coil conductors, an opening portion provided by overlying many more coil conductors on top of one another in the Z-axis direction (the laminating direction of the multiple insulating layers) is used as the “coil opening” (see the coil opening AP indicated in FIGS. 2A and 2B).

As illustrated in FIGS. 2A and 2B, the entirety of the six terminal electrodes T1 to T6 overlaps the coil opening AP of the coils (the coil L1 and the auxiliary coil L2) when viewed in the Z-axis direction. The six terminal electrodes T1 to T6 do not overlap the coils (the coil conductors L11 to L17 and the auxiliary coil L2) when viewed in the Z-axis direction. The six terminal electrodes T1 to T6 are disposed closer to the protrusion portion B1, than to the center of the coil opening AP, when viewed in the Z-axis direction. Terminal electrodes, such as the dummy electrodes, for example, may be disposed near the center of the coil opening AP.

As illustrated in FIG. 2B, in a cross section obtained by cutting the device body 10 along a plane (XZ plane) parallel or substantially parallel to the Z-axis direction, the minimum distance W2 is shorter than the conductor width (line width) W1 of the coils (W1>W2), where the minimum distance W2 indicates the minimum distance from an outer edge portion of the coils (the coil L1 and the auxiliary coil L2) to an end portion of the device body 10.

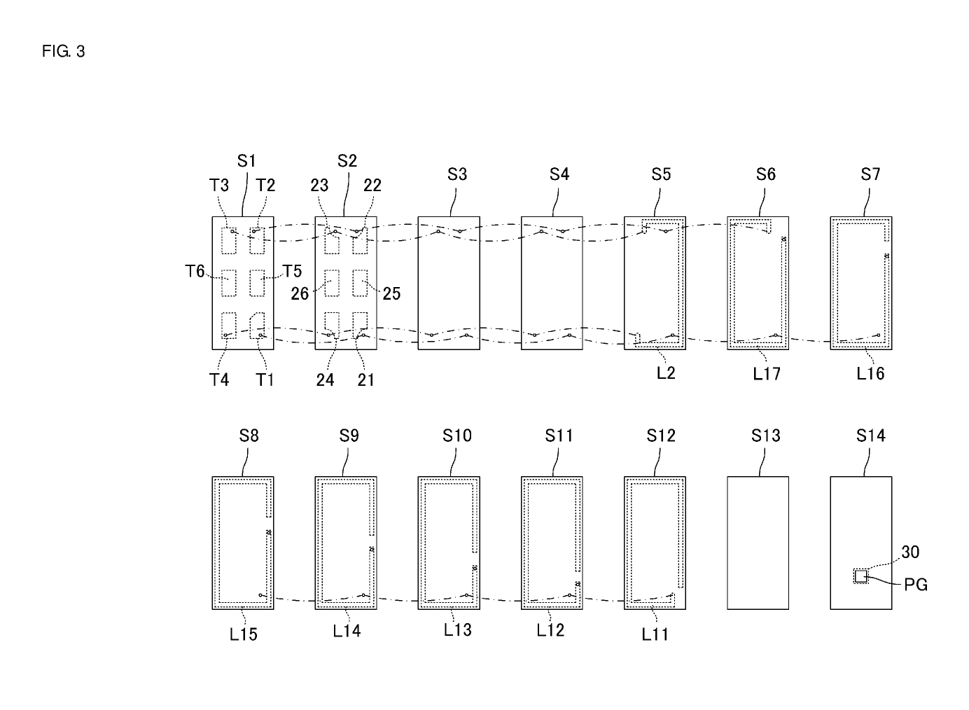

The specific structure of the device body 10 will be described. FIG. 3 is a plan view of the multiple insulating layers S1 to S14 of the coil device 301. Chain double-dashed lines in FIG. 3 indicate main connection relationships of the layer connecting conductors.

The device body 10 is provided by laminating the insulating layers S1, S2, S3, S4, S5, S6, S7, S8, S9, S10, S11, S12, S13, and S14 in this sequence. In FIG. 3, the insulating layer S1 is the bottom layer. The insulating layer S14 is the top layer. The insulating layers S1, S2, S5 to S12, and S14 are preferably green sheets, for example, made of low temperature co-fired ceramics (LTCC) non-magnetic material ferrite. The insulating layers S3, S4, and S13 are preferably green sheets, for example, made of low temperature co-fired ceramics (LTCC) magnetic ferrite.

The terminal electrodes T1, T2, T3, T4, T5, and T6 are provided on the back side of the insulating layer S1. The terminal electrodes T1 to T6 are preferably rectangular or substantially rectangular conductor patterns, for example. Conductors 21, 22, 23, 24, 25, and 26 are provided on the back side of the insulating layer S2. The conductors 21 to 26 are preferably conductor patterns having (rectangular or substantially rectangular) shapes similar to the terminal electrodes T1 to T6, respectively. The conductors 21 to 26 are conductor patterns whose main component is preferably, for example, Ag.

Frame-shaped insulating films (see the insulating films 1 in FIG. 2B) covering the outer edge portions of the terminal electrodes T1 to T6 are provided on the back side of the insulating layer S1. The insulating films are preferably formed, for example, in the following manner: after the terminal electrodes T1 to T6 are formed on the back side of the insulating layer S1, non-magnetic material (non-magnetic ferrite) pastes, with which the frames are printed so that the outer edge portions of the terminal electrodes T1 to T6 are covered, are fired.

The auxiliary coil L2, preferably including less than about one turn, for example, is provided on the back side of the insulating layer S5. The coil conductor L17, preferably including about one turn, for example, is provided on the back side of the insulating layer S6. The coil conductor L16, preferably including about one turn, for example, is provided on the back side of the insulating layer S7. The coil conductor L15, preferably including about one turn, for example, is provided on the back side of the insulating layer S8. The coil conductor L14, preferably including about one turn, for example, is provided on the back side of the insulating layer S9. The coil conductor L13, preferably including about one turn, for example, is provided on the back side of the insulating layer S10. The coil conductor L12, preferably including about one turn, for example, is provided on the back side of the insulating layer S11. The coil conductor L11, preferably including about one turn, for example, is provided on the back side of the insulating layer S12.

A position mark PG (a mark for facilitating positioning in manufacturing) is provided on the surface of the insulating layer S14. A conductor 30 is provided on the back side of the insulating layer S14. The position mark PG is preferably a rectangular or substantially rectangular conductor pattern, for example. The conductor 30 preferably has a (rectangular or substantially rectangular) shape similar to the position mark PG. The position mark PG and the conductor 30 are conductor patterns whose main component is preferably, for example, Ag.

The coil device 301 according to the present preferred embodiment produces the following advantageous effects.

In the present preferred embodiment, the entirety of the terminal electrodes T1 to T6 overlaps the coil opening AP of the coils (the coil L1 and the auxiliary coil L2) when viewed in the Z-axis direction (the laminating direction of the multiple insulating layers). In this configuration, the terminal electrodes T1 to T6 are provided in a portion, having improved flatness, of the mounting surface MS1 (a portion in which the protrusion portion B1 is unlikely to be provided). Therefore, compared with the case in which terminal electrodes are provided at positions (positions at which the coils are overlaid when viewed in the Z-axis direction) at which the protrusion portion B1 is likely to be provided, a coil device including the mounting surface MS1 with improved flatness is able to be achieved. Thus, a coil device which has outstanding mountability when the coil device is mounted on an external circuit substrate or other suitable substrate and which reduces or prevents mounting failure of the coil device on an external circuit substrate or other suitable substrate is able to be achieved.

Compared with the case in which terminal electrodes are provided at positions at which the protrusion portion B1 is likely to be provided, the configuration enables the size of the coil device to be easily decreased (enables a coil device, whose height in the Z-axis direction is small, to be easily obtained).

In the present preferred embodiment, the terminal electrodes T1 to T6 do not overlap the coils (the coil L1 and the auxiliary coil L2) when viewed in the Z-axis direction (the laminating direction of the multiple insulating layers). In this configuration, the terminal electrodes T1 to T6 are disposed at positions, at which the flatness is especially high, on the mounting surface MS1. Therefore, a coil device in which the flatness of the mounting surface MS1 is outstanding and which has high mountability when the coil device is mounted on an external circuit substrate or other suitable substrate is able to be achieved. As described in detail below (see, for example, a third preferred embodiment), the coil devices of preferred embodiments of the present invention each include the configuration in which a portion of the coils is disposed in the coil opening AP when viewed in the Z-axis direction.

In the present preferred embodiment, the protrusion portion B1 is provided between the terminal electrodes T1 to T6 and the end portions of the device body 10 when viewed in the Z-axis direction (the laminating direction of the multiple insulating layers). The coil devices of preferred embodiments of the present invention may be subjected to deburring or chamfering in barrel finishing processing. In this processing, terminal electrodes provided on the surface of the device body may be cut away or may fall off. In contrast, in the present configuration, the protrusion portion B1 is provided between the terminal electrodes T1 to T6 and the end portions of the device body 10. Therefore, the terminal electrodes T1 to T6 are prevented from being cut away by using media, for example.

In the present preferred embodiment, the frame-shaped insulating films 1 are provided on the mounting surface MS1 of the device body 10 so as to cover the outer edge portions of the terminal electrodes T1 to T6. This configuration causes the outer edge portions of the terminal electrodes T1 to T6 to be covered by the insulating films 1, thus reducing or preventing the terminal electrodes T1 to T6 from falling off the mounting surface MS1. The insulating films 1 may cover portions of the outer edge portions of the terminal electrodes.

In the present preferred embodiment, the minimum distance W2 from an outer edge portion of the coils (the coil L1 and the auxiliary coil L2) to an end portion of the device body 10 is preferably shorter than the conductor width W1 (line width) of the coils (W1>W2). This configuration enables a coil, with a larger coil diameter relative to the size of the device body 10, to be provided. Therefore, the range and distance in which magnetic flux radiates (concentrates) may be relatively increased, resulting in a coil device (coil antenna) having good communication characteristics.

In the present preferred embodiment, conductor patterns (the terminal electrode T1 to T4 and the conductors 21 to 26 which are positioned on the front and back sides of the insulating layer S1; the position mark PG and the conductor 30 which are positioned on the front and back sides of the insulating layer S14) positioned on the front and back sides of an insulating layer preferably have the same or substantially the same shape. This configuration reduces or prevents deformation, such as a warping, caused by the difference in contraction rate during firing between the material of the insulating layers and the conductor patterns.

In the present preferred embodiment, the device body 10 preferably includes magnetic material. This configuration enables a coil device, having a given inductance value, to be obtained without increasing the size of the device body 10.

In general, a magnetic material layer is easy to shrink during firing. In the case in which the magnetic material layer is disposed only on one surface side, a warp or other deformation easily occurs in the device body during firing. In contrast, the device body 10 according to the present preferred embodiment has a vertically symmetrical structure in which the coils (the coil L1 and the auxiliary coil L2) are interposed between the first magnetic layer ML1 and the second magnetic layer ML2, so as to reduce or prevent deformation, such as warping, which is produced during firing, in the device body.

In the case in which the coil device 301 is used as a coil antenna, it is preferable to include only the first magnetic layer ML1. In this configuration, the magnetic shield effect of the first magnetic layer ML1 reduces or prevents the state in which a magnetic field from the coils radiates to the mounting surface MS1 side. Therefore, when the coil device 301 is mounted on a circuit substrate or other suitable substrate, unnecessary coupling between the coils and a conductor positioned on the mounting surface MS1 side is able to be reduced or prevented.

In the present preferred embodiment, the example of the device body 10 (coil device 301) including the first magnetic layer ML1 and the second magnetic layer ML2 is described. However, this configuration is not limiting. Almost the entirety of the device body (excluding conductor portions) may be made of magnetic material. That is, for example, all of the multiple insulating layers of the device body may be made of magnetic material.

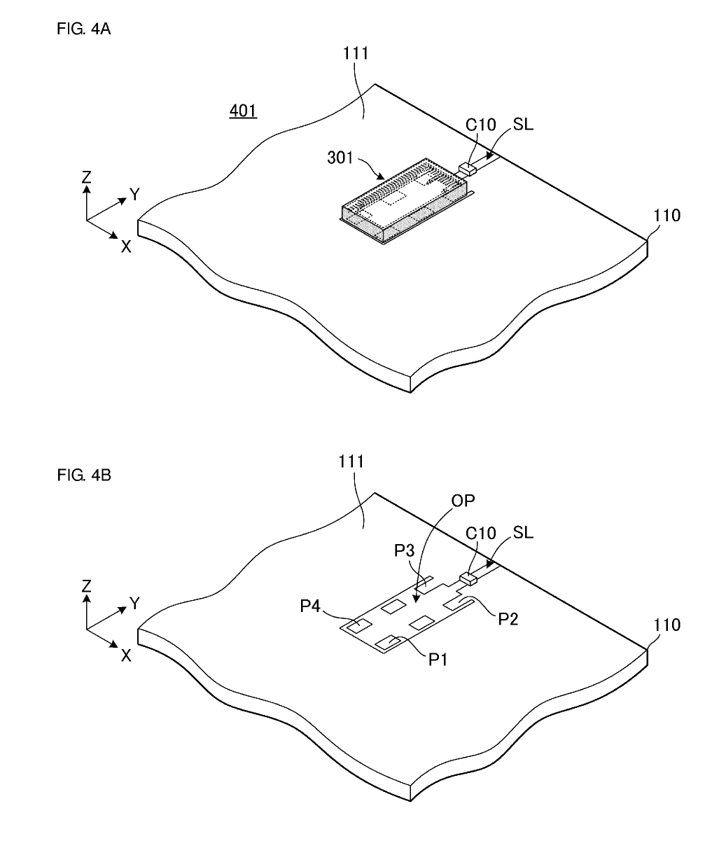

The coil device according to the present preferred embodiment is preferably used, for example, as follows. FIG. 4A is a perspective view of an antenna device 401 according to the first preferred embodiment. FIG. 4B is a perspective view of the state in which the coil device 301 is removed from the antenna device 401.

The antenna device 401 includes a circuit substrate 110, a sheet conductor 111 provided on the circuit substrate 110, and the coil device 301 mounted on the circuit substrate 110. The antenna device 401 is preferably used, for example, in a reader/writer in an RFID system in which NFC is used for communication, or a tag. The antenna device 401 is included, for example, in electronic equipment having an NFC communication function.

As illustrated in FIG. 4A, the sheet conductor 111 includes a conductor opening OP and a slit SL connecting the conductor opening OP to an outer edge of the sheet conductor 111. The coil device 301 is mounted so as to overlap the conductor opening OP, and is positioned in proximity to the sheet conductor 111. The winding axis of the coil device 301 extends in the vertical or substantially vertical direction with respect to the surface of the sheet conductor 111. The coil opening (see the coil opening AP in FIG. 1B) of the coil device 301 overlaps the conductor opening OP. Two terminal electrodes (the terminal electrodes T1 and T4 in FIG. 2) of the coil device are connected to an RFIC (not illustrated), which is provided on the circuit substrate 110, via pads P1 and P4. Another two terminal electrodes (the terminal electrodes T2 and T3 in FIG. 2) of the coil device 301 are connected to the sheet conductor 111 via pads P2 and P3.

A first capacitor C10 is mounted on the circuit substrate 110 so as to cross the slit SL, and is connected across the slit SL. The sheet conductor 111 is magnetically coupled to the coil device 301, thus producing an induction current in the sheet conductor 111. The first capacitor C10 and the inductance of the sheet conductor 111 define a resonant circuit, so as to increase the degree of coupling to a communication target and improve the antenna characteristics.

### Second Preferred Embodiment

In a second preferred embodiment of the present invention, an example in which coils are exposed on the end surfaces of a device body will be illustrated.

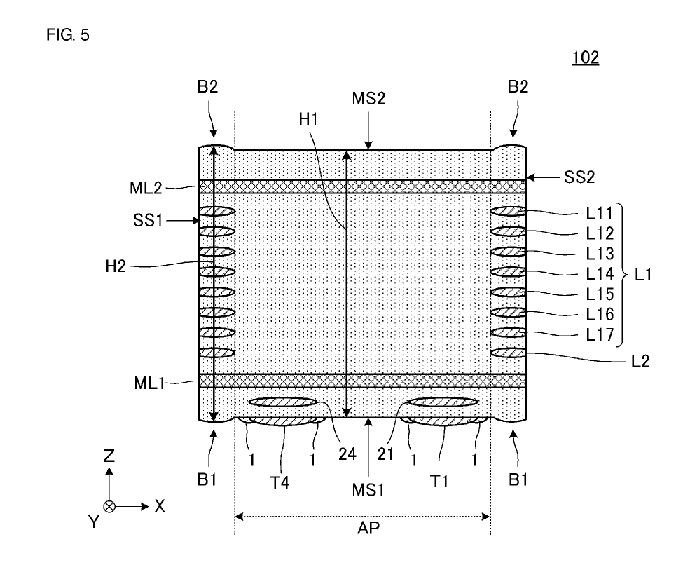

FIG. 5 is a sectional view of a coil device 302 according to the second preferred embodiment.

The coil device 302 is different from the coil device 301 according to the first preferred embodiment in that the coils (the coil L1 and the auxiliary coil L2) are exposed on end surfaces SS1 and SS2 of the device body 10. The remaining configuration of the coil device 302 is the same or substantially the same as that of the coil device 301.

Even in this configuration, the basic structure of the coil device 302 is the same or substantially the same as that of the coil device 301 according to the first preferred embodiment, and produces advantageous effects the same as or similar to those of the coil device 301.

### Third Preferred Embodiment

In a third preferred embodiment of the present invention, an exemplary coil device having a different coil shape will be illustrated.

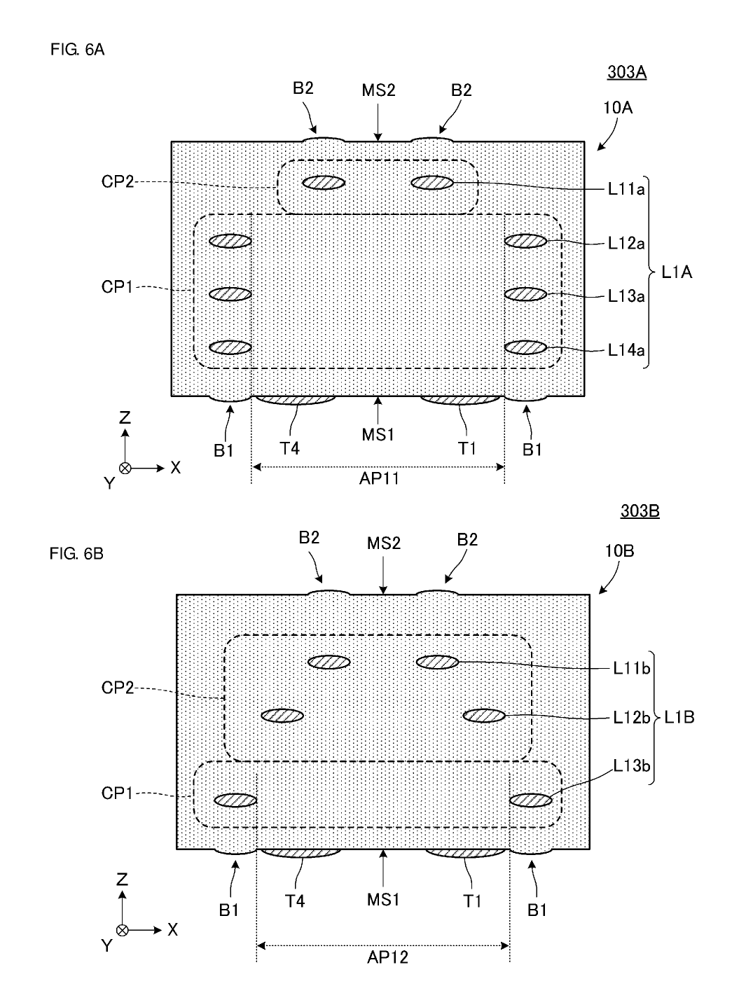

FIG. 6A is a sectional view of a coil device 303A according to the third preferred embodiment. FIG. 6B is a sectional view of a coil device 303B according to the third preferred embodiment.

The coil devices 303A and 303B are different from the coil device 301 according to the first preferred embodiment in that an auxiliary coil is not included. The coil devices 303A and 303B are different from the coil device 301 in terms of the shape and structure of the coil. Further, the coil devices 303A and 303B are different from the coil device 301 in that the device body does not include magnetic material layers (the first magnetic layer and the second magnetic layer). The remaining configuration of the coil devices 303A and 303B is the same or substantially the same as that of the coil device 301.

Points different from those of the coil device 301 according to the first preferred embodiment will be described below.

As illustrated in FIG. 6A, a coil L1A is provided in a device body 10A of the coil device 303A. The coil L1A preferably includes about four turns and has a winding axis parallel or substantially parallel to the Z-axis direction, and includes coil conductors L11a, L12a, L13a, and L14a and multiple layer connecting conductors (not illustrated). The coil conductors L12a to L14a substantially overlap one another when viewed in the Z-axis direction. In contrast, the coil conductor L11a does not overlap the coil conductors L12a to L14a when viewed in the Z-axis direction.

The coil L1A includes a first coil conductor portion CP1 and a second coil conductor portion CP2 connected in series to the first coil conductor portion CP1. The first coil conductor portion CP1 is positioned on the mounting surface MS1 side relative to the second coil conductor portion CP2 in the Z-axis direction (the laminating direction of the multiple insulating layers), of the coil L1A.

The entirety of the six terminal electrodes (in FIG. 6A, only the terminal electrodes T1 and T4 are illustrated) overlaps a coil opening AP11 of the first coil conductor portion CP1 when viewed in the Z-axis direction. The six terminal electrodes overlap the second coil conductor portion CP2 (coil conductor L11a) when viewed in the Z-axis direction.

As illustrated in FIG. 6B, a coil L1B is provided in a device body 10B of the coil device 302B. The coil L1B is preferably a conical coil which includes about three turns, for example, and has a winding axis parallel or substantially parallel to the Z-axis direction, and includes coil conductors L11b, L12b, and L13b and multiple layer connecting conductor (not illustrated). The coil conductors L11b to L13b do not overlap one another when viewed in the Z-axis direction.

The coil L1B includes the first coil conductor portion CP1 and the second coil conductor portion CP2 connected in series to the first coil conductor portion CP1. The first coil conductor portion CP1 is positioned on the mounting surface MS1 side relative to the second coil conductor portion CP2 in the Z-axis direction (the laminating direction of the multiple insulating layers), of the coil L1B.

The entirety of the six terminal electrodes (in FIG. 6B, only the terminal electrodes T1 and T4 are illustrated) overlaps a coil opening AP12 of the first coil conductor portion CP1 when viewed in the Z-axis direction. The six terminal electrodes overlap the second coil conductor portion CP2 (coil conductors L11b and L12b) when viewed in the Z-axis direction.

The “first coil conductor portion” indicates a portion, which is positioned on the mounting surface MS1 side relative to the second coil conductor portion CP2 in the Z-axis direction, of the coil. In the case in which, in the coil, multiple coil conductors positioned on the mounting surface MS1 side overlap one another when viewed in the Z-axis direction, a portion in which the conductors overlap one another is regarded as a “first coil conductor portion” (see the first coil conductor portion CP1 in FIG. 6A). In the case in which multiple coil conductors do not overlap one another when viewed in the Z-axis direction, the coil conductor which is disposed closest to the mounting surface MS1 is regarded as a “first coil conductor portion” (see the first coil conductor portion CP1 in FIG. 6B).

As described above, typically, as the conductor patterns provided in the device body are disposed at positions closer to the mounting surface MS1, the amount of the protrusion of the protrusion portion B1 from the device body surface tends to increase. In the present preferred embodiment, the entirety of the terminal electrodes overlaps the coil opening AP11 or AP12 of the first coil conductor portion CP1 when viewed in the Z-axis direction (the laminating direction of the multiple insulating layers). That is, the terminal electrodes are disposed in a portion, having high flatness, of the mounting surface MS1 (a portion in which the protrusion portion B1 is unlikely to be provided). Therefore, this configuration enables a coil device in which the flatness of the mounting surface MS1 is high, compared with the case in which the terminal electrodes are disposed at positions at which the protrusion portion B1 is likely to be provided (positions at which the first coil conductor portion CP1 is overlain when viewed in the Z-axis direction).

In terms of an advantageous effect described above, it is preferable that the minimum distance from an outer edge portion of the first coil conductor portion CP1 to an end portion of the device body is shorter than the conductor width (line width) of the coil.

In terms of an advantageous effect described above, the device body preferably includes magnetic material. In terms of an advantageous effect described above, the device body preferably has a vertically symmetrical structure so as to be sandwiched between the first magnetic layer and the second magnetic layer. The first magnetic layer is positioned on the mounting surface MS1 side relative to the first coil conductor portion CP1. The second magnetic layer is positioned on the top surface MS2 side relative to the coil. However, the configuration of the device body is not limited to the configuration having the first magnetic layer and the second magnetic layer. The device body may have a configuration including only the first magnetic layer or a configuration including only the second magnetic layer.

In the preferred embodiments described above, examples in which the device body has rectangular or substantially rectangular parallelepiped-shaped are described. However, this configuration is not limiting. The shape of the device body may be changed appropriately in the range in which the advantageous effects of the present invention are produced. The planar shape of the device body may be, for example, a circle, an ellipse, a polygon, a T-shape, a Y-shape, or an L-shape.

In the preferred embodiments described above, examples in which the device body has a laminated structure including 14 insulating layers are described. However, this configuration is not limiting. The number of insulating layers of the device body may be changed appropriately in the range in which the advantageous effects of the present invention are produced.

In the preferred embodiments described above, examples in which the six terminal electrodes T1 to T6 are included are described. However, this configuration is not limiting. The number of terminal electrodes may be changed appropriately in the range in which the advantageous effects of the present invention are produced. The shape of each terminal electrode is not limited to a rectangle or substantially a rectangle, and may be changed appropriately in the range in which the advantageous effects of the present invention are produced. The shape of each terminal electrode may be, for example, a polygon, a circle, an ellipse, a T-shape, a Y-shape, or an L-shape.

In the preferred embodiments described above, examples of the device body in which a conductor (such as a coil) is provided in a low temperature co-fired ceramics (LTCC) dielectric ceramic are described. However, this configuration is not limiting. The device body may have, for example, a laminated structure including thermoplastic resin sheets whose main material is preferably polyimide (PI), liquid crystal polymer (LCP), or other suitable material, for example. The device body may preferably have a laminated structure including multiple insulating layers of thermosetting resin, for example.

In the preferred embodiments described above, examples in which a coil including about three, four, or seven turns is provided in the device body are described. However, this configuration is not limiting. The number of coils provided in the device body, the shapes of the coils, and the number of turns may be changed appropriately in the range in which the advantageous effects of the present invention are produced.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A coil device mounted on a circuit substrate, the coil device comprising:
a device body having a laminated structure including a plurality of insulating layers, the device body including a mounting surface orthogonal or substantially orthogonal to a laminating direction of the plurality of insulating layers;
a coil provided in the device body and including about one turn or more; and
terminal electrodes provided on the mounting surface, and connected to pads provided on the circuit substrate; wherein
an entirety of the terminal electrodes overlaps a coil opening of the coil when viewed in the laminating direction; and
an entirety of the device body overlaps the circuit substrate when viewed in the laminating direction.

2. The coil device according to claim 1, wherein, in the device body, a thickness, in the laminating direction, of a portion overlying the coil when viewed in the laminating direction is larger than a thickness, in the laminating direction, of a portion overlying the coil opening when viewed in the laminating direction.

3. The coil device according to claim 1, wherein a minimum distance from an outer edge portion of the coil to an end portion of the device body is shorter than a conductor width of the coil.

4. The coil device according to claim 1, wherein the device body includes a magnetic material.

5. The coil device according to claim 4, wherein the magnetic material includes a first magnetic layer positioned on a side of the mounting surface relative to the coil.

6. The coil device according to claim 4, wherein
the device body includes a top surface facing the mounting surface; and
the magnetic material includes a second magnetic layer positioned on a side of the top surface relative to the coil.

7. A coil device comprising:
a device body having a laminated structure including a plurality of insulating layers, the device body including a mounting surface orthogonal or substantially orthogonal to a laminating direction of the plurality of insulating layers;
a coil provided in the device body and including a plurality of turns; and
terminal electrodes provided on the mounting surface, and connected to pads provided on a circuit substrate; wherein
the coil includes a first coil conductor portion and a second coil conductor portion connected in series to the first coil conductor portion;
the first coil conductor portion is positioned on a side of the mounting surface relative to the second coil conductor portion in the laminating direction;
an entirety of the terminal electrodes overlaps a coil opening of the first coil conductor portion when viewed in the laminating direction; and
an entirety of the device body overlaps the circuit substrate when viewed in the laminating direction.

8. The coil device according to claim 7, wherein, in the device body, a thickness, in the laminating direction, of a portion overlying the first coil conductor portion when viewed in the laminating direction is larger than a thickness, in the laminating direction, of a portion overlying the coil opening of the first coil conductor portion when viewed in the laminating direction.

9. The coil device according to claim 7, wherein a minimum distance from an outer edge portion of the first coil conductor portion to an end portion of the device body is shorter than a conductor width of the first coil conductor portion.

10. The coil device according to claim 7, wherein the device body includes a magnetic material.

11. The coil device according to claim 10, wherein the magnetic material includes a first magnetic layer positioned on a side of the mounting surface relative to the first coil conductor portion.

12. The coil device according to claim 10, wherein
the device body includes a top surface facing the mounting surface; and
the magnetic material includes a second magnetic layer positioned on a side of the top surface relative to the coil.

13. An antenna device comprising:
a circuit substrate;
a sheet conductor provided on the circuit substrate; and
the coil device according to claim 1.

14. The antenna device according to claim 13, wherein
the sheet conductor includes a conductor opening and a slit connecting the conductor opening to an outer edge of het sheet conductor; and
the coil device is mounted on the circuit substrate so as to overlap the conductor opening.

15. The antenna device according to claim 14, wherein
a winding axis of the coil device extends orthogonal or substantially orthogonal to a surface of the sheet conductor; and
the coil opening of the coil device overlaps the conductor opening.

16. The antenna device according to claim 13, further comprising a capacitor mounted on the circuit substrate, crossing the slit, and being connected to the sheet conductor across the slit.

17. An antenna device comprising:
a circuit substrate;
a sheet conductor provided on the circuit substrate; and
the coil device according to claim 7.

18. The antenna device according to claim 17, wherein
the sheet conductor includes a conductor opening and a slit connecting the conductor opening to an outer edge of het sheet conductor; and
the coil device is mounted on the circuit substrate so as to overlap the conductor opening.

19. The antenna device according to claim 18, wherein
a winding axis of the coil device extend orthogonal or substantially orthogonal to a surface of the sheet conductor; and
the coil opening of the coil device overlaps the conductor opening.

20. The antenna device according to claim 17, further comprising a capacitor mounted on the circuit substrate, crossing the slit, and being connected to the sheet conductor across the slit.
